(19) United States
(12) Patent Application Publication
(10) Pub. No.: US 2013/0080280 A1
(43) Pub. Date: Mar. 28, 2013

(54) ORDER PROVISION SYSTEM USING CUSTOMER PROXIMITY

(71) Applicant: Germán Carlos Scipioni, San Jose, CA (US)

(72) Inventor: Germán Carlos Scipioni, San Jose, CA (US)

(73) Assignee: EBAY, INC., San Jose, CA (US)

(21) Appl. No.: 13/241,857

(22) Filed: Sep. 23, 2011

(51) Int. Cl. G06Q 30/00

(52) U.S. Cl. 705/26.1

(57) ABSTRACT

A method for providing an order includes receiving an identifier for a customer order, which is to be provided at a merchant location, and a customer mobile device identifier through a network at a tracking device. The identifier for the customer order is associated with the customer mobile device identifier. A location of a customer mobile device that is associated with the customer mobile device identifier is determined. A distance between the customer mobile device and the merchant location is determined. The identifier for the customer order along with arrival information for the customer that is based on the distance between the location of the customer mobile device and the merchant location is then provided for display. A merchant at the merchant location may then make determinations about how to provide the customer order based on the customer arrival information.

### BACKGROUND

1. Field of the Invention

The present invention generally relates to online and/or mobile payments and more particularly to a order provision system using customer proximity.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

One of the many areas in which online and mobile payments is growing involves customers making payments to merchants for orders that the customer is planning on picking up or retrieving from the merchant's location. For example, a customer may quickly and easily make an online and/or mobile order for food at a restaurant and pay for that order using online and/or mobile payments, either while at home or out of the home while the customer is busy doing other things. The customer may then travel to the restaurant, often with the mobile device that may even have been used to place the order, to pick up the order. However, the restaurant that receives this order and other orders will then address those orders in the order in which they were received, resulting in some orders being ready long before customers arrive at the restaurant, while requiring other customers to wait at the restaurant while their orders are completed. Conventional order provisioning systems have attempted to leverage customer mobile devices by sending a message (e.g., a text message) to a mobile device when the order ready. Such order provisioning systems may allow a customer to avoid showing up at the restaurant before their order is ready, but still suffer from orders being ready long before the customers arrive at the restaurant because the customer is not close enough to the restaurant when the message is received.

Thus, there is a need for an improved order provisioning system.

### SUMMARY

According to one embodiment, a method for providing orders includes associating customer order identifiers with customer mobile device identifiers, and then using the customer mobile device identifiers to continuously or periodically determining the distances between customer mobile devices and a merchant location where customer orders are to be provided. The customer order identifiers and customer arrival information, which is based on the distances between the customer mobile devices and the merchant location, may then be provided for display to allow the merchant to adjust the provision of orders based on when the customers will arrive at the merchant location.

In an embodiment, the method may determine arrival times for each of the customer mobile devices at the merchant location, and the displayed order identifiers may be prioritized based on the determined arrival times to assist the merchant with adjusting the provision of orders. Arrival times may be determined based on the distance between the customer mobile devices and the merchant location, traffic information, historical customer data, and/or a variety of other information known in the art.

As a result, the merchant may optimize the provision of orders to customers. In an embodiment, orders may be food orders, and the method allows the merchant to provide orders to customers by prioritizing the orders for the customers that will arrive at the merchant location relatively soon over the orders for the customers that will arrive later, which ensures that customers orders are “fresh” and increases customer satisfaction. In another embodiment, orders may include appointment times or reservations, and the method allows the merchant to hold appointment times or reservations for customers who will arrive on time, while pushing appointment times or reservations to a later time for customers who will arrive late.

These and other features and advantages of the present disclosure will be more readily apparent from the detailed description of the embodiments set forth below taken in conjunction with the accompanying figures.

### BRIEF DESCRIPTION OF THE FIGURES

FIG. 1 is a flow chart illustrating an embodiment of a method for providing an order;

FIG. 2a is a front view illustrating an embodiment of a customer device being used to place an order;

FIG. 2b is a front view illustrating an embodiment of a customer device being used to provide a customer mobile device identifier;

FIG. 3 is a front view illustrating an embodiment of a merchant device being used to display orders along with customer proximity;

FIG. 4 is a front view illustrating an embodiment of a customer device being used to make an appointment;

FIG. 5 is a front view illustrating an embodiment of a merchant device being used to display appointments along with customer proximity.

FIG. 6 is a schematic view illustrating an embodiment of a networked system;

FIG. 7 is a perspective view illustrating an embodiment of a customer device;

FIG. 8 is a schematic view illustrating an embodiment of a computer system; and

FIG. 9 is a schematic view illustrating an embodiment of a payment service provider device, an account provider device, a merchant device, and/or a tracking device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

One embodiment of the present disclosure provides a system and method for providing orders based on the proximity of the customers that placed those orders to a merchant location. A plurality of customers may place orders with a merchant and provide the merchant with customer mobile device identifiers for their mobiles devices. The merchant may then associate the customer mobile device identifiers with identifiers for the orders placed by the customers. A tracking device may then monitor the location of the customer mobile devices using the customer mobile device identifiers, and use the locations of the customer mobile devices to determine customer arrival information that indicates when the customer will arrive at the merchant location. That customer arrival information may then be displayed along with the customer orders. The system and method allow a merchant to adjust the provision of orders based on the proximity of the customers that made those orders so that customers arriving at the merchant location relatively earlier may have their orders prioritized over customers that will be arriving at the merchant location relatively later.

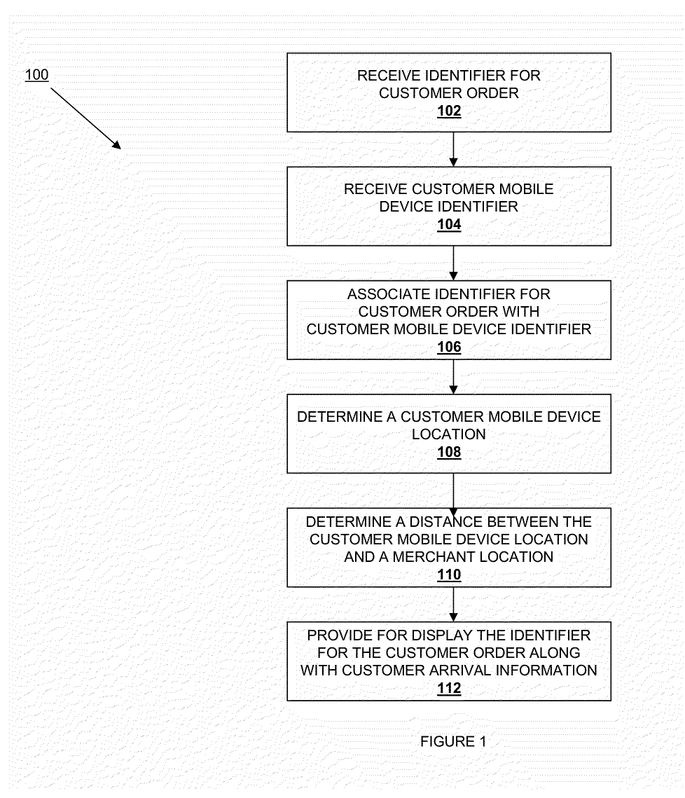

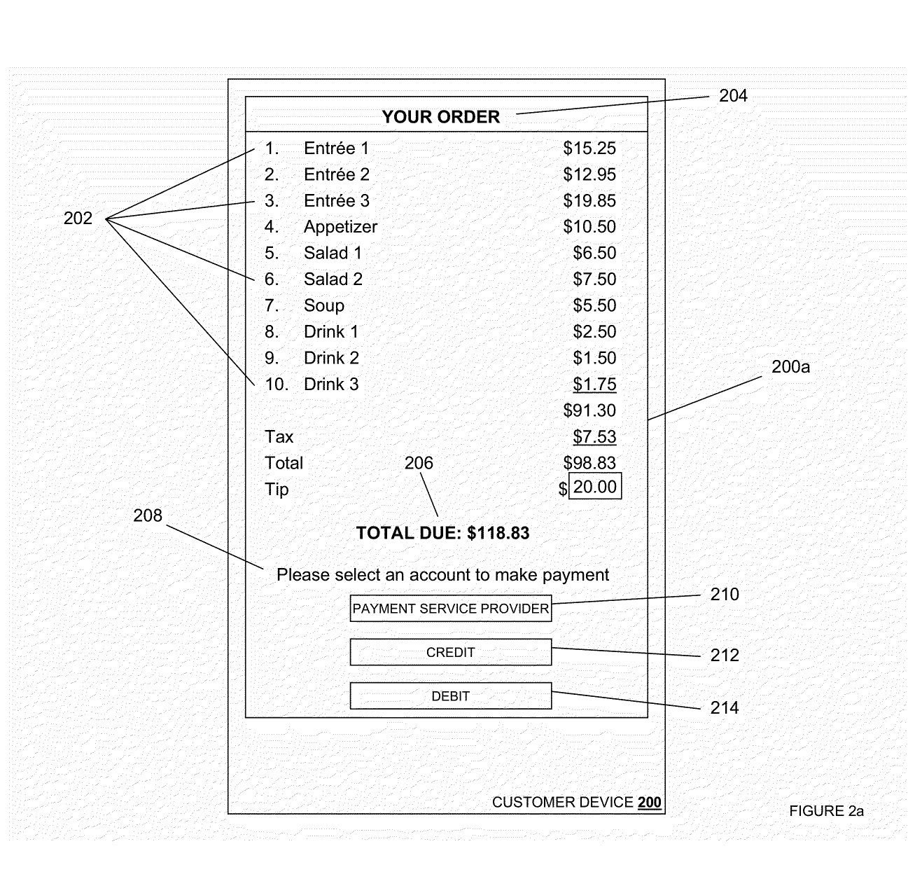

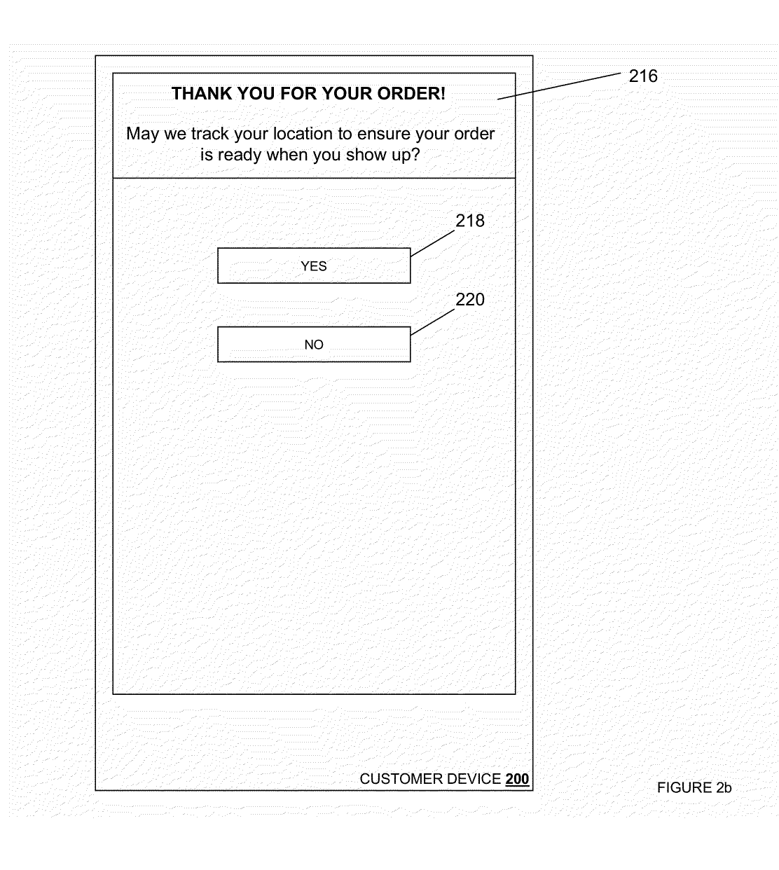

Referring now to FIGS. 1 and 2a, a method 100 for providing orders is illustrated. In the embodiment of the method 100 described below, an account provider provides a customer with a payment account, and the customer may use the payment account to fund payments for purchases made from merchants. In another embodiment, a payment service provider such as, for example, PayPal, Inc. of San Jose, Calif., assists in the making of payments from the customer to the merchant by transferring funds from the payment account to a merchant account of the merchant. However, these embodiments are meant to be merely exemplary, and one of skill in the art will recognize that a variety of modifications may be made to the system discussed below without departing from the scope of the present disclosure.

The method 100 begins at block 102 where an identifier for a customer order is received. In an embodiment, a customer may use a customer device 200 having a display 200a, illustrated in FIG. 2a, to connect to a merchant device (described in further detail below) over a network (e.g., the Internet). In the embodiment illustrated and described below, the merchant device is operated by a restaurant merchant that provides food orders for customers. However, a variety of other merchants known in the art may use the merchant device to practice the method 100 discussed below without departing from the scope of the present disclosure. In the illustrated embodiment, the customer may select a plurality of items 202 (e.g., entrees, appetizers, salads, soups, drinks, etc.) using the customer device 200 (e.g., using an application or webpage provided over a network by the merchant device or a third party device), over the phone, and/or using a variety of other methods know in the art. Those plurality of items 202 make up a customer order 204 that also includes a payment amount due 206. The customer may then be presented (e.g., on the customer device 200 in the illustrated embodiment) with a payment window 208 that provides the customer the option of paying the payment amount due 206 by selecting a payment service provider button 210, a credit button 212, a debit button 214, and/or a variety of other payment options known in the art.

For example, the customer may select the payment service provider button 210 in the payment window 208 in order to use a payment account of the customer that is provided by a payment service provider in order to provide payment for the payment amount due 206 on the order 204. In one embodiment, upon selection of the payment service provider button 210, the customer device 200 may be connected over the network to a payment service provider device of a payment service provider, and the customer may provide user credentials in order to access a payment account provided by the payment service provider. The customer may then be asked (e.g., on the customer device 200) to confirm payment for the payment amount due 206, and in response to receiving the confirmation over the network at the payment service provider device, the payment service provider may then transfer a payment to the merchant for the payment amount due 206 from the payment account. In an embodiment, that payment may be funded from the payment account provided by the payment service provider, from an account (e.g., the credit or debit account discussed below) provided by an account provider that is different from the payment service provider, and/or from a variety of other payment accounts known in the art.

In another example, the customer may select the credit button 212 or debit button 214 in the payment window 208 in order to use a payment account that is provided for the customer by a credit account provider or debit account provider in order to provide payment for the payment amount due 206 on the order 204. In one embodiment, upon selection of the credit button 212 or debit button 214, the customer device 200 may be connected over the network to an account provider device of an account provider, and the customer may provide user credentials in order to access the credit account or debit account provided by the account provider. The customer may then be asked (e.g., on the customer device 200) to confirm payment for the payment amount due 206, and in response to receiving the confirmation over the network at the account provider device, the account provider may then transfer a payment to the merchant for the payment amount due 206 from the credit account or debit account.

In another example, the customer may not provide a payment for the payment amount due 206 for the order 204 at block 102 of the method 100. For example, the customer may wish to pay cash to the merchant upon picking up the order 204 at the merchant location, and thus may decline to make payment. In response to making a payment or declining to make a payment of the payment amount due 206 for the order 204, the order 204 may be submitted to the merchant by sending the order 204 from the customer device 200 to the merchant device over the network.

Submission of the order to the merchant device results in an identifier for the customer order being provided to a tracking device (e.g., over the network from the customer device 200). In an embodiment, the tracking device may be the merchant device, the payment service provider device, the account provider device, and/or a tracking device operated by a third party that performs the method 100. In an embodiment, the identifier may be an order number associated with the customer order, may include details of the customer order, and/or may include a variety of other identifiers that may be used to reference the customer order placed by the customer. Furthermore, while the embodiment illustrated above is directed to the placing of the customer order by the customer with the merchant using the customer device 200, the customer order may instead be placed by the customer with the merchant over a phone without departing from the scope of the present disclosure. In such an embodiment, the identifier for the customer order may the be provided to the tracking device by the merchant or other party upon receiving the customer order. The identifier for the customer order, the details of the customer order, and/or a variety of other customer order related information may then be stored in a database that is coupled to the tracking device.

Referring now to FIGS. 1 and 2b, the method 100 then proceeds to block 104 where a customer mobile device identifier is received. In an embodiment, after making the payment or declining to make the payment as described above, the customer may be presented with a tracking request screen 216 on the customer device 200. The tracking request screen 216 may be provided to the customer device 200 over the network by the tracking device. The tracking request screen 216 includes a request to track the customer's location along with a “yes” button 218 and a “no” button 220. In response to the customer selecting the “yes” button 218, a customer mobile device identifier is sent by the customer device 200 over the network and received by the tracking device. The customer mobile device identifier may be any identifier for a customer mobile device (e.g., a phone number) that distinguishes that customer mobile device from other customer mobile devices. In another embodiment, the tracking request screen 216 may be presented to the customer on the customer device 200 before the customer places the order, during the customer placing the order, during the payment process, and/or at a variety of other times without departing from the scope of the present disclosure. For example, a customer may select the “yes” button 218 on the tracking request screen 216 when placing a previous order, and that consent to track the customer location may be used on subsequent orders.

The method 100 then proceeds to block 106 where the identifier for the customer order is associated with the customer mobile device identifier. Upon receiving the customer mobile device identifier in block 104 of the method 100, the tracking device may associate the customer mobile device identifier with the identifier for the customer order received in block 102 of the method 100, and the customer mobile device identifier may then be stored with the identifier for the customer order in the database. One of skill in the art will recognize that the method 100 may be performed with a plurality of different customers providing a plurality of orders such that a plurality of identifiers for respective customer orders are then associated with respective customer mobile device identifiers and stored in the database.

Referring back to FIG. 1, the method 100 then proceeds to block 108 where a customer mobile device location is determined. Upon associating the customer mobile device identifier with the identifier for the customer order, the tracking device may then begin tracking the customer mobile device location of that customer mobile device. In an embodiment, the tracking device may periodically or continuously retrieve the customer mobile device location from the customer mobile device. In another embodiment, the customer mobile device may periodically or continuously send the customer mobile device location to the tracking device. The customer mobile device location may include mapping coordinates such as, for example, Global Positioning System (GPS) coordinates that are determined using a GPS system in the customer device 200, a cell tower triangulation system in the customer device 200, and/or a variety of other device locating systems known in the art. Customer mobile device locations received by the tracking device are associated with the customer mobile device identifier discussed above, and the customer mobile device identifier is then used to associate the customer mobile device locations with the identifier for the customer order in the database.

The method 100 then proceeds to block 110 where a distance between the customer mobile device location and a merchant location is determined. The tracking device may retrieve a merchant location of the merchant, which may include mapping coordinates such as, for example, Global Positioning System (GPS) coordinates. The tracking device may then use the merchant location and the customer mobile device location to determine a distance between the customer mobile device location and the merchant location using methods known in the art. For example, the tracking device may include a street map of the area surrounding the merchant location, and may determine the points on the street map where the merchant location and the customer mobile device location are presently located (e.g., using the mapping coordinates included in the customer mobile device location and the merchant location). The tracking device may then determine the shortest route on the street map from customer mobile device location to the merchant location, and then determine the distance of that route. While one example of determining the distance between the customer mobile device location and the merchant location has been provided, one of skill in the art will recognize that a variety of other techniques for determining a distance between mapping coordinates may be used without departing from the scope of the present disclosure. For example, rather than determining the shortest route on the street map to determine the distance, the tracking device may determine the most likely route (which may not be the shortest route) using, for example, historical travel patterns of that customer or other previous customers that have been saved in a database.

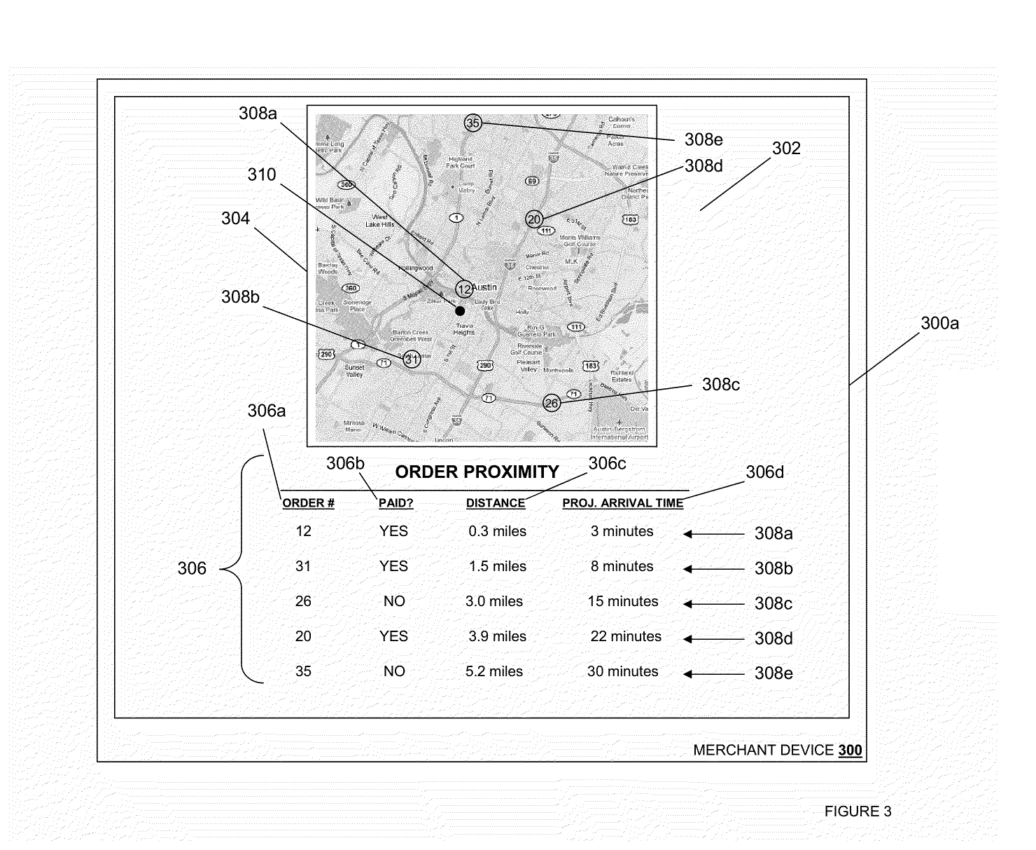

Referring now to FIGS. 1 and 3, the method 100 then proceeds to block 112 where the identifier for the customer order is provided along with customer arrival information for display. FIG. 3 illustrates a merchant device 300 having a display 300a. A tracking screen 302 is illustrated that is displayed on the display 300a and includes a tracking map 304 and an order proximity section 306. The order proximity section 306 includes columns for an order number 306a, a payment confirmation 306b, a distance 306c, and a projected arrival time 306d. A plurality of orders 308a, 308b, 308c, 308d, and 308e are graphically displayed over the tracking map 304 and listed in the order proximity section 306. Each of the plurality of orders 308a, 308b, 308c, 308d, and 308e includes an identifier for the customer order (e.g., the order number 306a for each customer order), customer arrival information (e.g., the distance 306c for each customer order from the merchant location 310 and/or the projected arrival time 306d for each order), and an indication of whether the order has been paid for (e.g., the payment confirmation 306b for each order).

The tracking device may provide some or all of the information for display on the display 300a of merchant device 300 by being part of the merchant device 300 or being connected to the merchant device 300 over a network. The tracking device may use the customer mobile device location (e.g., mapping coordinates), determined in block 110 of the method 100, and the merchant location (e.g., mapping coordinates) to provide the orders 308a, 308b, 308c, 308d, and 308e and the merchant location 310 graphically displayed on the tracking map 304, as illustrated in FIG. 3. As can been seen, each of the orders 308a, 308b, 308c, 308d, and 308e may be graphically displayed on the tracking map 304 using the identifier for that order (e.g., the order 308a is displayed on the tracking map 304 using its associated identifier (e.g., order number 12)). Furthermore, as the tracking device determines that the customer mobile device locations for customer orders changes, the graphical displays of the orders 308a, 308b, 308c, 308d, and 308e on the tracking map 304 will move to display accurate locations for each of the orders 308a, 308b, 308c, 308d, and 308e on the tracking map 304 that correspond to current customer mobile device locations that are associated with those orders.

The tracking device may also use the distance between the customer mobile device location and the merchant location determined in block 110 to provide customer arrival information, along with the identifier for the customer order, for display in the order proximity section 306. In an embodiment, the provision of the distance 306c for each order 308a, 308b, 308c, 308d, and 308e is customer arrival information for those orders. However, the tracking device may also provide (along with or in place of the distance 306c) the projected arrival time 306d for each order 308a, 308b, 308c, 308d, and 308e as customer arrival information for those orders. For example, as discussed above, the tracking device may include a street map of the area surrounding the merchant location (e.g., the tracking map 304), and may determine the points on the street map where the merchant location (e.g., merchant location 310) and the customer mobile device locations (e.g., the orders 308a, 308b, 308c, 308d, and 308e) are presently located. Then, for each order 308a, 308b, 308c, 308d, and 308e, the tracking device may then determine the shortest route on the street map from that order to the merchant location. The tracking device may then estimate the arrival time of the customer mobile device (and thus, the customer) at the merchant location for each order.

In one embodiment, the tracking device may divide the distance between the customer mobile device location and the merchant location by the estimated average speed (e.g., a current average speed, a historical average speed, etc.) of the customer mobile device to produce the estimated arrival time. In an embodiment, the tracking device may modify the estimated average speed of the customer mobile device depending on the time of day, traffic information that is received over the network, and/or using a variety of other information known in the art. In an embodiment, the estimated arrival time may be at least partly based on historical data of previous orders. For example, the tracking device may retrieve historical order data of one or more previous customers that were located in the same location as a current customer at approximately the same time, and use their travel times to the merchant location to estimate the arrival time of the current customer. While some examples have been provided to produce an estimated arrival time for an order, one of skill in the art will recognize that an estimated arrival time of an order may be produced in a variety of ways without departing from the scope of the present disclosure.

The tracking device may also prioritize the orders 308a, 308b, 308c, 308d, and 308e in the order proximity section 306 based on the customer arrival information. For example, the orders 308a, 308b, 308c, 308d, and 308e illustrated in FIG. 3 have been prioritized using the customer arrival information such that orders that are closer to the merchant location and that have lower projected arrival times at the merchant location are listed before orders that are further away from the merchant location and that have higher projected arrival times at the merchant location. As can be seen, orders may have been placed earlier in time (e.g., the orders 306c and 306d having order numbers 26 and 20, respectively) and still be prioritized lower than a later placed order (e.g., the order 308b having order number 31) due to the tracking system determining that the earlier placed orders are further away from the merchant location and/or are projected to arrive later at the merchant location than the later placed order. Furthermore, as customer mobile device locations are updated, distances between customer mobile device locations and the merchant location may change, which may cause projected arrival times at the merchant location to change and result in the reprioritization of the orders 308a, 308b, 308c, 308d, and 308e in the order proximity section 306.

Thus, a system and method are provided that track the location of customers that have placed orders with a merchant. In an embodiment, the tracking may be performed by a merchant device at the merchant location that receives the customer orders, may receive payment for the customer orders, tracks the customers locations en route to the merchant location, and provides the customer locations associated with the customer orders for display on the merchant device. In another embodiment, the tracking may be performed by payment service provider devices or account provider devices that may receive payment for the customer orders, track the customers locations en route to the merchant location, and provide the customer locations associated with the customer orders over the network for display on the merchant device. In yet another embodiment, the tracking may be performed by a third party tracking device that tracks the customer locations en route to the merchant location and provides the customer locations associated with the customer orders over the network for display on the merchant device. In any of these embodiments, a merchant may then display the customer locations associated with the customer orders to determine when to prepare the customer orders so that they are ready when the customers arrive at the merchant location. Furthermore, as the merchant will know when the customer is located at the merchant location, the merchant may bring the order out to the customer when they arrive at the merchant location.

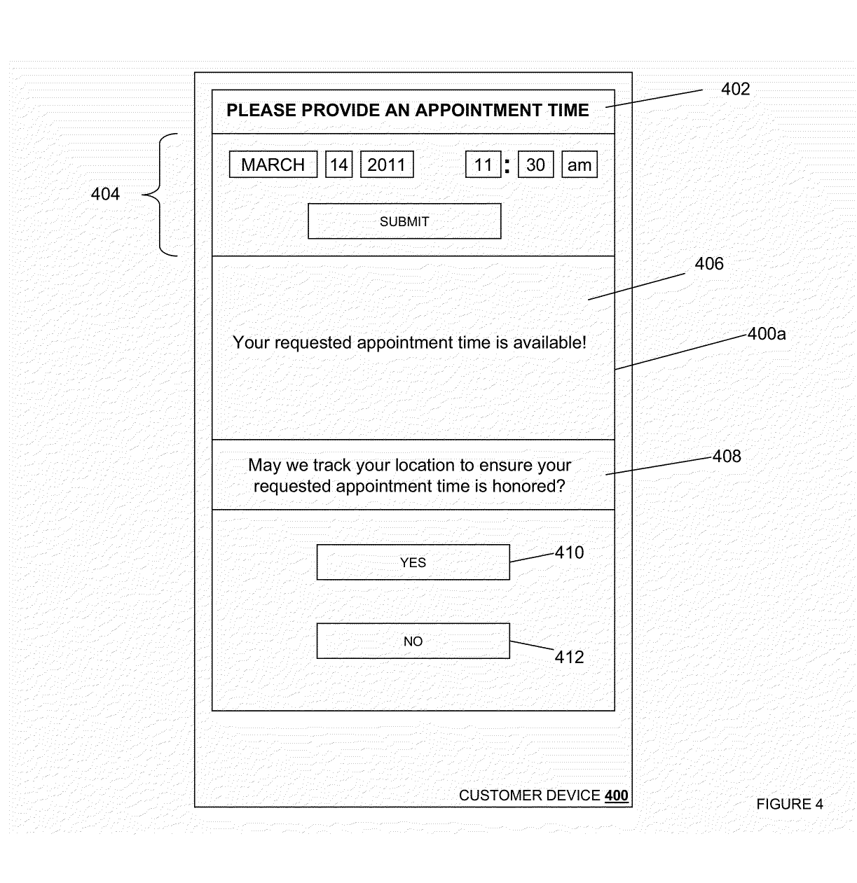

Referring now to FIGS. 1, 4, and 5, an alternative embodiment of the method 100 is illustrated. The embodiment of the method 100 is substantially similar to the embodiment discussed above with reference to FIGS. 1, 2a, 2b, and 3, with the provision of modified blocks 102 and 112. As discussed above, at block 102, an identifier for a customer order is received. In this embodiment, the customer order is a customer reservation or appointment. For example, the merchant device may be operated by a restaurant merchant that accepts reservations for customers, a doctor merchant that accepts appointments for customers, a hair stylist merchant that accepts appoints for customers, and/or a variety of other merchants that provide customer reservation and/or appointment services known in the art. In the illustrated embodiment, the merchant device (or a third party provider device) may provide the customer device 400 with an appointment screen 402 that includes an appointment time section 404. The customer may then use the customer device 400 to submit an appointment time, and the customer device 400 may then be provided an appointment confirmation section 406 on the appointment screen 402 (e.g., if the appointment time is available). Along with the appointment confirmation section 406, the customer device 400 may be provided a tracking request section 408 that requests permission to track the customer device 400. The tracking request section 408 may then include a “yes” button 410 and a “no” button 412. If the customer selects the “yes” button 410, the method 100 then proceeds to blocks 104, 106, 108, and 110 substantially as discussed above. However, at block 108, the determining the customer mobile device location may not be performed until a predetermined amount of time before the appointment time (e.g., 1 hour before the appointment time).

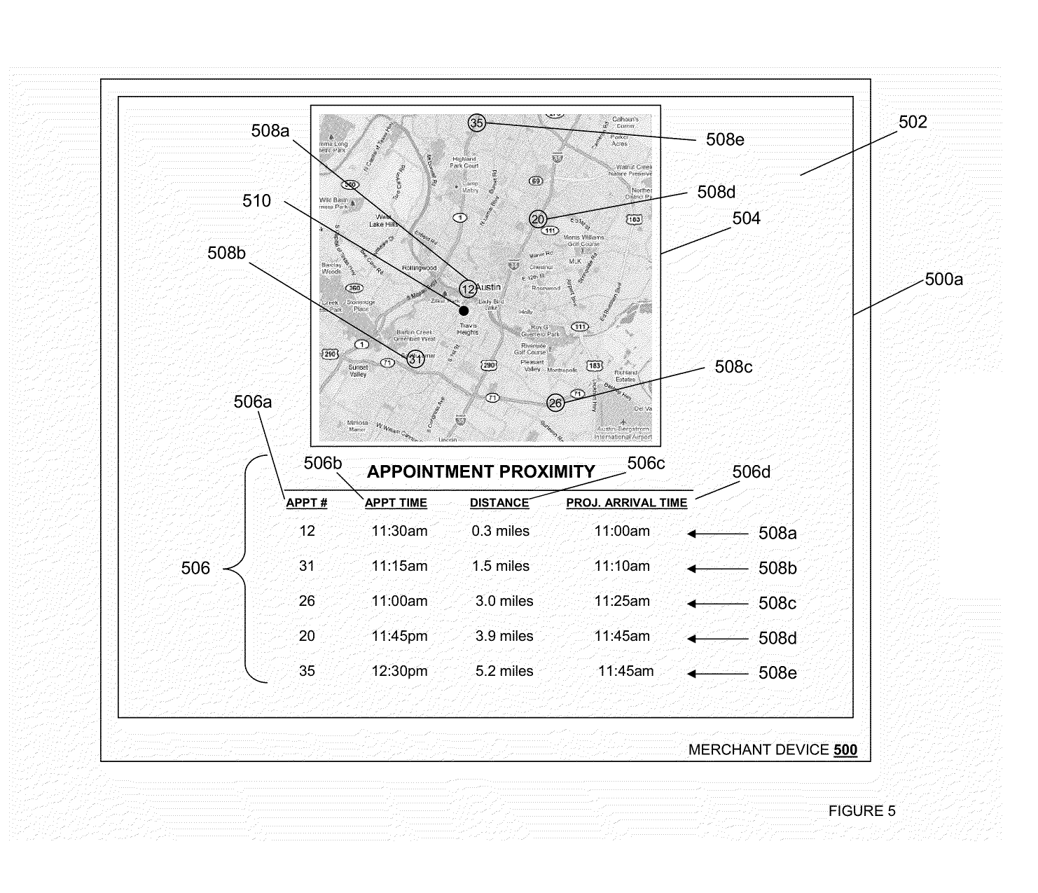

At block 112 of the method 100, the identifier for the customer order along with customer arrival information are provided for display. FIG. 5 illustrates a merchant device 500 having a display 500a. A tracking screen 502 is illustrated displayed on the display 500a and includes a tracking map 504 and an appointment proximity section 506. The order proximity section 506 includes columns for appointment number 506a, appointment time 506b, distance 506c, and projected arrival time 506d. A plurality of appointments 508a, 508b, 508c, 508d, and 508e are included in the tracking map 504 and the appointment proximity section 506. Each of the plurality of appointments 508a, 508b, 508c, 508d, and 508e includes an identifier for the customer order (e.g., the appointment number 506a for each customer order), customer arrival information (e.g., the distance 506c for each customer order and/or the projected arrival time 506d for each order), and a time associated with the order (e.g., the appointment time 506b for each order).

The tracking device operates substantially as described above to provide the appointments 508a, 508b, 508c, 508d, and 508e and the merchant location 510 for display on the tracking map 504, and to provide customer arrival information along with the identifier for the customer order for display in the appointment proximity section 506. The tracking device may also prioritize the appointments 508a, 508b, 508c, 508d, and 508e in the appointment proximity section 506 based on the customer arrival information. For example, the appointments 508a, 508b, 508c, 508d, and 508e illustrated in FIG. 5 have been prioritized using the customer arrival information such that appointments associated with customers that are closer to the merchant location and that are projected to arrive earlier at the merchant location are listed before orders that are associated with customers that are further away from the merchant location and that are projected to arrive later at the merchant location.

Thus, a system and method are provided that track the location of customers that have appointments and/or reservations with a merchant. The tracking may be performed by a merchant device at the merchant location that receives the customer orders/appointments, or by a third party tracking device that tracks the customer locations en route to the merchant location and provides the customer locations associated with the customer orders over the network for display on the merchant device. A merchant may then display the customer locations associated with the customer appointments to determine how to honor customer appointments and/or reservations. For example, appointment 508a has an appointment at 11:30 am but is projected to arrive at 11:00 am, while appointment 508c has an appointment at 11:00 am but is projected to arrive at 11:25 am. Thus, the merchant could push the appointment time for appointment 508a up to 11:00 am, while saving the 11:30 am appointment time for appointment 508c.

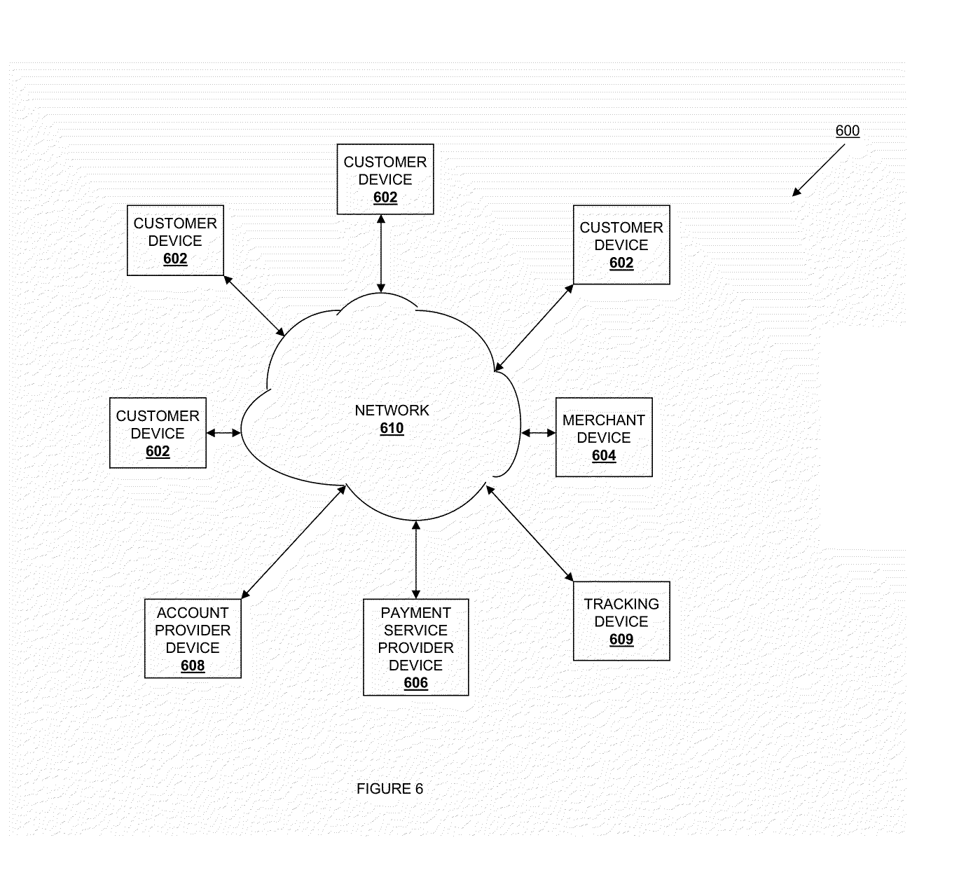

Referring now to FIG. 6, an embodiment of a networked system 600 used in the order provision system described above is illustrated. The networked system 600 includes a plurality of customer devices 602, a merchant device 604, a payment service provider device 606, an account holder device 608, and a tracking device 609 in communication over a network 610. Any of the customer devices 602 may be the customer devices 200 and/or 400, discussed above. The merchant device 604 may be the merchant devices 300 and/or 500 discussed above and may be operated by the merchants discussed above. The payment service provider device 606 may be the payment service provider devices discussed above and may be operated by a payment service provider such as, for example, PayPal Inc. of San Jose, Calif. The account provider device 608 may be the account provider devices discussed above and may be operated by the account providers discussed above such as, for example, credit card account providers, bank account providers, savings account providers, and a variety of other account providers known in the art. The tracking device 609 may be the tracking devices discussed above and may be included in the merchant device 604, the payment service provider device 606, the account provider device 608, and/or operated by a third party as the tracking device 609 illustrated in FIG. 6.

The customer devices 602, merchant device 604, payment service provider device 606, account provider device 608, and tracking device 609 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 600, and/or accessible over the network 610.

The network 610 may be implemented as a single network or a combination of multiple networks. For example, in various embodiments, the network 610 may include the Internet and/or one or more intranets, landline networks, wireless networks, and/or other appropriate types of networks.

The customer devices 602 may be implemented using any appropriate combination of hardware and/or software configured for wired and/or wireless communication over network 610. For example, in one embodiment, the customer devices 602 may be implemented as a personal computer of a user in communication with the Internet. In other embodiments, the customer devices 602 may be a smart phone, personal digital assistant (PDA), laptop computer, and/or other types of computing devices.

The customer devices 602 may include one or more browser applications which may be used, for example, to provide a convenient interface to permit the customer to browse information available over the network 610. For example, in one embodiment, the browser application may be implemented as a web browser configured to view information available over the Internet.

The customer devices 602 may also include one or more toolbar applications which may be used, for example, to provide user-side processing for performing desired tasks in response to operations selected by the customer. In one embodiment, the toolbar application may display a user interface in connection with the browser application.

The customer devices 602 may further include other applications as may be desired in particular embodiments to provide desired features to the customer devices 602. In particular, the other applications may include a payment application for payments assisted by a payment service provider through the payment service provider device 606. The other applications may also include security applications for implementing user-side security features, programmatic user applications for interfacing with appropriate application programming interfaces (APIs) over the network 610, or other types of applications. Email and/or text applications may also be included, which allow the customer to send and receive emails and/or text messages through the network 610. The customer devices 602 include one or more user and/or device identifiers which may be implemented, for example, as operating system registry entries, cookies associated with the browser application, identifiers associated with hardware of the customer devices 602, or other appropriate identifiers, such as a phone number. In one embodiment, the user identifier may be used by the merchant device, the payment service provider device 606, the account provider device 608, and/or the tracking device 609 to associate the customer with a particular account as further described herein.

The merchant device 604 may be maintained, for example, by a conventional or on-line merchant, conventional or digital goods seller, individual seller, and/or application developer offering various products and/or services in exchange for payment to be received conventionally or over the network 610. In this regard, the merchant device 604 may include a database identifying available products and/or services (e.g., collectively referred to as items) which may be made available for viewing and purchase by the customer.

The merchant device 604 also includes a checkout application which may be configured to facilitate the purchase by the payer of items. The checkout application may be configured to accept payment information from the customer through the customer device 602, the account provider through the account provider device 608, and/or from the payment service provider through the payment service provider device 606 over the network 610.

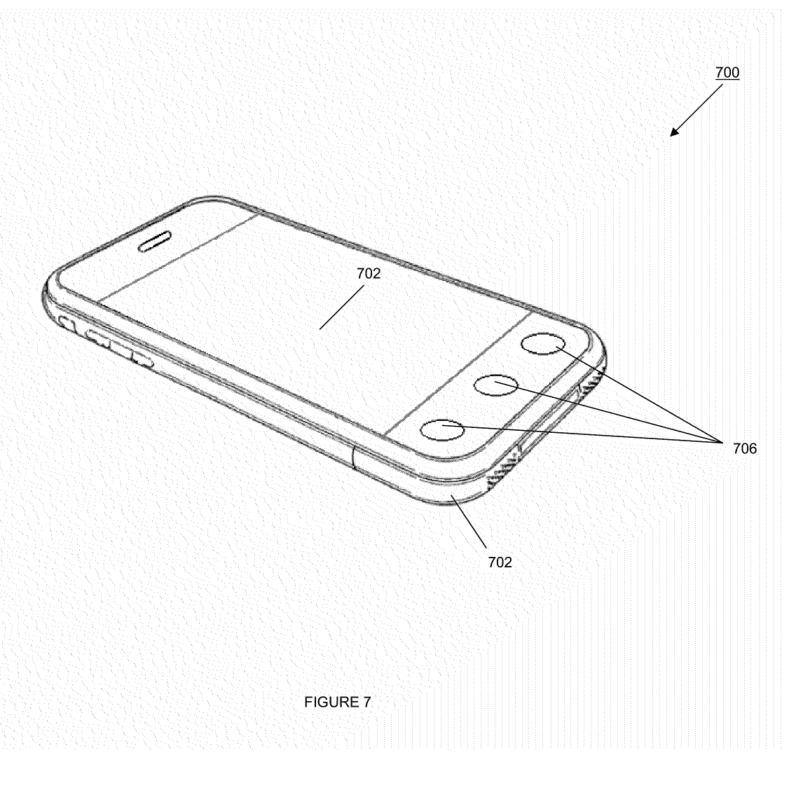

Referring now to FIG. 7, an embodiment of a customer device 700 is illustrated. The customer device 700 may be the customer devices 200, 400, and/or 602. The customer device 700 includes a chassis 702 having a display 704 and an input device including the display 704 and a plurality of input buttons 706. One of skill in the art will recognize that the payer device 700 is a portable or mobile phone including a touch screen input device and a plurality of input buttons that allow the functionality discussed above with reference to the method 100. However, a variety of other portable/mobile payer devices and/or desktop payer devices may be used in the method 100 without departing from the scope of the present disclosure.

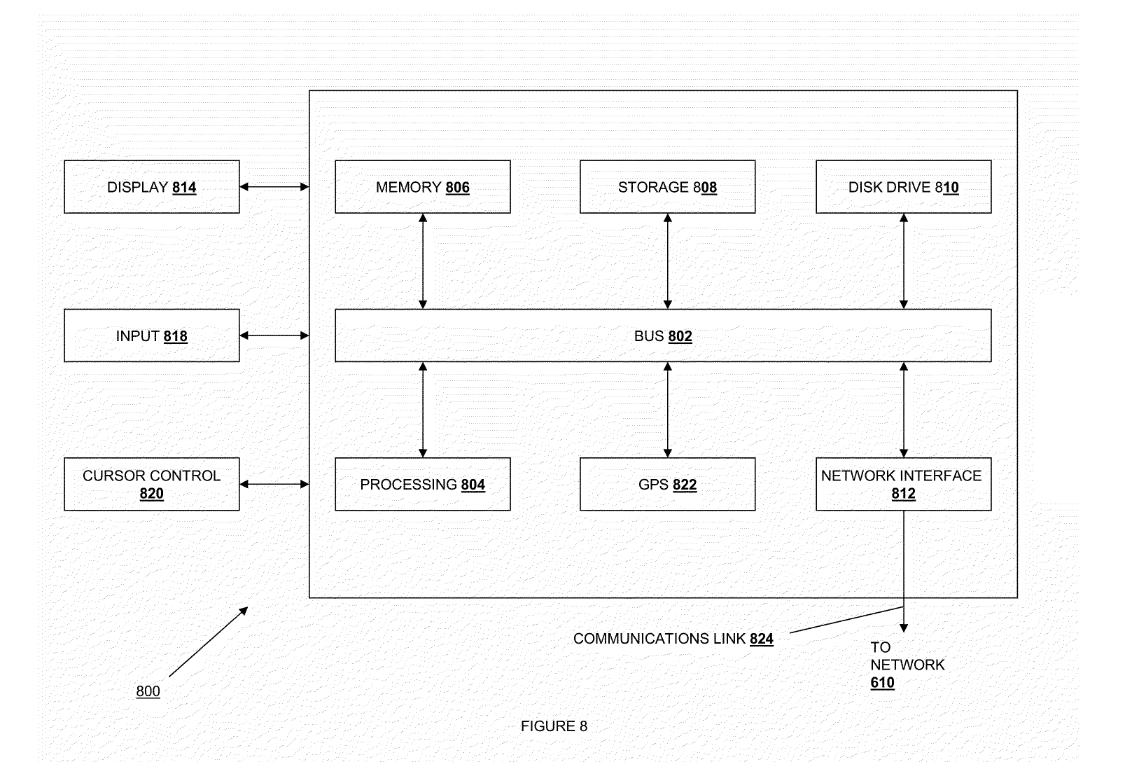

Referring now to FIG. 8, an embodiment of a computer system 800 suitable for implementing, for example, the customer devices 200, 400, 602, and/or 700, the merchant devices 300, 500, and/or 604, the payment service provider device 606, the account provider device 608, and/or the tracking device 609 is illustrated. It should be appreciated that other devices utilized by customers, merchants, payment service providers, account providers, and third parties in the order provision system discussed above may be implemented as the computer system 800 in a manner as follows.

In accordance with various embodiments of the present disclosure, computer system 800, such as a computer and/or a network server, includes a bus 802 or other communication mechanism for communicating information, which interconnects subsystems and components, such as a processing component 804 (e.g., processor, micro-controller, digital signal processor (DSP), etc.), a system memory component 806 (e.g., RAM), a static storage component 808 (e.g., ROM), a disk drive component 810 (e.g., magnetic or optical), a network interface component 812 (e.g., modem or Ethernet card), a display component 814 (e.g., CRT or LCD), an input component 818 (e.g., keyboard, keypad, or virtual keyboard), a cursor control component 820 (e.g., mouse, pointer, or trackball), and/or a location determination component 822 (e.g., a Global Positioning System (GPS) device as illustrated, a cell tower triangulation device, and/or a variety of other location determination devices known in the art.) In one implementation, the disk drive component 810 may comprise a database having one or more disk drive components.

In accordance with embodiments of the present disclosure, the computer system 800 performs specific operations by the processor 804 executing one or more sequences of instructions contained in the memory component 806, such as described herein with respect to the customer devices 200, 400, 602, and 700, the merchant device(s) 300, 500, and 604, the payment service provider device 606, the account provider device(s) 608, and/or the tracking device 609. Such instructions may be read into the system memory component 806 from another computer readable medium, such as the static storage component 808 or the disk drive component 810. In other embodiments, hard-wired circuitry may be used in place of or in combination with software instructions to implement the present disclosure.

Logic may be encoded in a computer readable medium, which may refer to any medium that participates in providing instructions to the processor 804 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 810, volatile media includes dynamic memory, such as the system memory component 806, and transmission media includes coaxial cables, copper wire, and fiber optics, including wires that comprise the bus 802. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 800. In various other embodiments of the present disclosure, a plurality of the computer systems 800 coupled by a communication link 824 to the network 610 (e.g., such as a LAN, WLAN, PTSN, and/or various other wired or wireless networks, including telecommunications, mobile, and cellular phone networks) may perform instruction sequences to practice the present disclosure in coordination with one another.

The computer system 800 may transmit and receive messages, data, information and instructions, including one or more programs (i.e., application code) through the communication link 824 and the network interface component 812. The network interface component 812 may include an antenna, either separate or integrated, to enable transmission and reception via the communication link 824. Received program code may be executed by processor 804 as received and/or stored in disk drive component 810 or some other non-volatile storage component for execution.

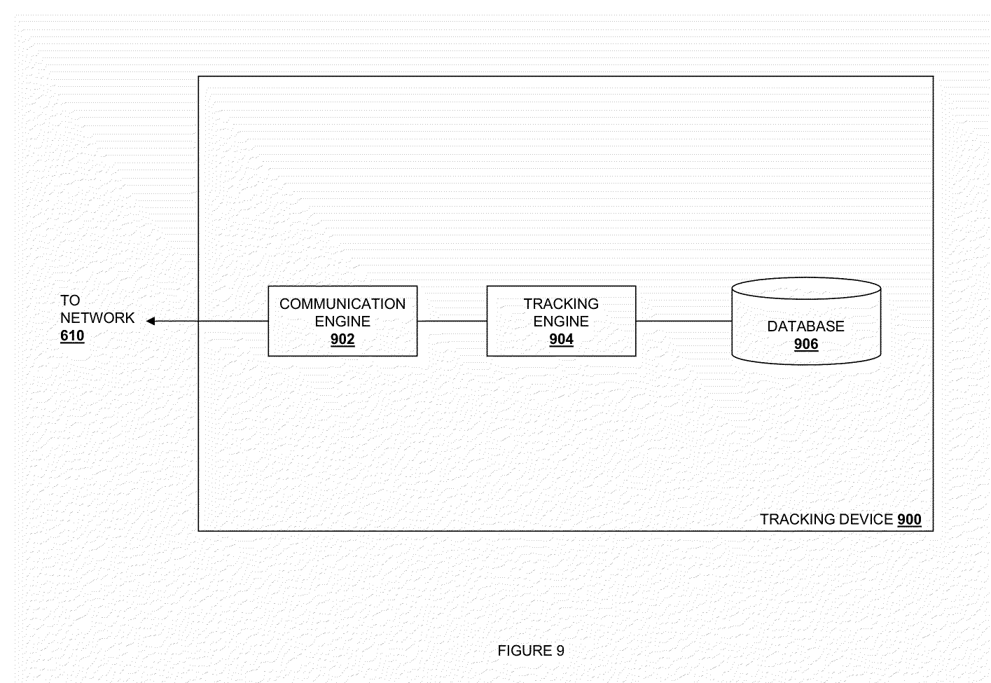

Referring now to FIG. 9, an embodiment of a tracking device 900 is illustrated. In an embodiment, the tracking device 900 may be the merchant device 300, 500, and/or 604, the payment service provider device 606, the account holder device 608, and/or the tracking device 609. The device 900 includes a communication engine 902 that is coupled to the network 610 and to an tracking engine 904 that is coupled to a database 906. The communication engine 902 may be software or instructions stored on a computer-readable medium that allows the device 900 to send and receive information over the network 610. The tracking engine 904 may be software or instructions stored on a computer-readable medium that is operable to receive identifiers for customer orders, customer mobile device identifiers, associate the identifiers for the customers orders and the customer mobile device identifiers in the database 906, determine the customer mobile device locations, determine the distance between the customer mobile device location and the merchant location, provide the identifier for the customer order along with customer arrival information for display, and/or provide any of the other functionality that is discussed above. While the database 906 has been illustrated as located in the tracking device 900, one of skill in the art will recognize that it may be connected to the tracking engine 904 through the network 610 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on customers and merchants; however, a customer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a customer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method for providing an order, comprising:
receiving an identifier for a first customer order through a network at a tracking device, wherein the first customer order is to be provided at a merchant location;
receiving a first customer mobile device identifier through the network at the tracking device;
associating the identifier for the first customer order with the first customer mobile device identifier;
determining a location of a first customer mobile device that is associated with the first customer mobile device identifier;
determining a distance between the location of the first customer mobile device and the merchant location; and
providing for display the identifier for the first customer order along with arrival information for the first customer that is based on the distance between the location of the first customer mobile device and the merchant location.

2. The method of claim 1, further comprising:
receiving a payment for the first customer order through the network at the tracking device.

3. The method of claim 2, further comprising:
providing for display an indication that the payment has been received along with the identifier for the first customer order.

4. The method of claim 1, wherein the arrival information for the first customer includes an arrival time for the first customer mobile device at the merchant location that is determined using the distance between the location of the first customer mobile device and the merchant location.

5. The method of claim 4, further comprising:
retrieving traffic information over the network at the tracking device, wherein the arrival time for the first customer mobile device at the merchant location is determined using the traffic information and the distance between the location of the first customer mobile device and the merchant location.

6. The method of claim 1, further comprising:
receiving an identifier for a second customer order through the network at the tracking device, wherein the second customer order is to be provided at the merchant location;
receiving a second customer mobile device identifier through the network at the tracking device;
associating the identifier for the second customer order with the second customer mobile device identifier;
determining a location of a second customer mobile device that is associated with the second customer mobile device identifier;
determining a distance between the location of the second customer mobile device and the merchant location;
providing for display the identifier for the second customer order along with arrival information for the second customer that is based on the distance between the location of the second customer mobile device and the merchant location; and
prioritizing the identifier for the first customer order relative to the identifier for the second customer order using the arrival information for the first customer and the arrival information for the second customer.

7. The method of claim 6, wherein the prioritizing further comprises:
determining an arrival time for the first customer mobile device at the merchant location using the distance between the location of the first customer mobile device and the merchant location;
determining an arrival time for the second customer mobile device at the merchant location using the distance between the location of the second customer mobile device and the merchant location; and
prioritizing the display of the identifier for first customer order and the display of the identifier for the second customer order using the arrival time for the first customer mobile device at the merchant location and the arrival time for the second customer mobile device at the merchant location.

8. The method of claim 1, wherein the first customer order is a food order.

9. A non-transitory machine-readable medium comprising a plurality of machine-readable instructions which, when executed by one or more processors, are adapted to cause the one or more processors to perform a method comprising:
receiving an identifier for a first customer order through a network at a tracking device, wherein the first customer order is to be provided at a merchant location;
receiving a first customer mobile device identifier through the network at the tracking device;
associating the identifier for the first customer order with the first customer mobile device identifier;
determining a location of a first customer mobile device that is associated with the first customer mobile device identifier;
determining a distance between the location of the first customer mobile device and the merchant location; and
providing for display the identifier for the first customer order along with arrival information for the first customer that is based on the distance between the location of the first customer mobile device and the merchant location.

10. The non-transitory machine-readable medium of claim 9, wherein the method further comprises:
receiving a payment for the first customer order through the network at the tracking device.

11. The non-transitory machine-readable medium of claim 10, wherein the method further comprises:
providing for display an indication that the payment has been received along with the identifier for the first customer order.

12. The non-transitory machine-readable medium of claim 9, wherein the arrival information for the first customer includes an arrival time for the first customer mobile device at the merchant location that is determined using the distance between the location of the first customer mobile device and the merchant location.

13. The non-transitory machine-readable medium of claim 12, wherein the method further comprises:
retrieving traffic information over the network at the tracking device, wherein the arrival time for the first customer mobile device at the merchant location is determined using the traffic information and the distance between the location of the first customer mobile device and the merchant location.

14. The non-transitory machine-readable medium of claim 9, wherein the method further comprises:
retrieving an identifier for a second customer order through the network at the tracking device, wherein the second customer order is to be provided at the merchant location;
receiving a second customer mobile device identifier through the network at the tracking device;
associating the identifier for the second customer order with the second customer mobile device identifier;
determining a location of a second customer mobile device that is associated with the second customer mobile device identifier;
determining a distance between the location of the second customer mobile device and the merchant location;
providing for display the identifier for the second customer order along with arrival information for the second customer that is based on the distance between the location of the second customer mobile device and the merchant location; and
prioritizing the identifier for the first customer order relative to the identifier for the second customer order using the arrival information for the first customer and the arrival information for the second customer.

15. The non-transitory machine-readable medium of claim 14, wherein the prioritizing further comprises:
determining an arrival time for the first customer mobile device at the merchant location using the distance between the location of the first customer mobile device and merchant location;
determining a second arrival time for the second customer mobile device at the merchant location using the distance between the location of the second customer device and the merchant location; and
prioritizing the display of the identifier for first customer order and the display of the identifier for the second customer order along with the second distance using the arrival time for the first customer mobile device at the merchant location and the arrival time for the second customer mobile device at the merchant location.

16. The non-transitory machine-readable medium of claim 9, wherein the first customer order is a food order.

17. An order provisioning system, comprising:
means for receiving an identifier for a first customer order, wherein the first customer order is to be provided at a merchant location;
means for receiving a first customer mobile device identifier;
means for associating the identifier for the first customer order with the first customer mobile device identifier;
means for determining a location of a first customer mobile device that is associated with the first customer mobile device identifier;
means for determining a distance between the location of the first customer mobile device and the merchant location; and
means for providing for display the identifier for the first customer order along with arrival information for the first customer that is based on the distance between the location of the first customer mobile device and the merchant location.

18. The system of claim 17, further comprising:
means for receiving a payment for the first customer order.

19. The system of claim 17, wherein the arrival information for the first customer includes an arrival time for the first customer mobile device at the merchant location that is determined using the distance between the location of the first customer mobile device and the merchant location.

20. The system of claim 19, further comprising:
means for retrieving traffic information, wherein the arrival time for the first customer mobile device at the merchant location is determined using the traffic information and the distance between the location of the first customer mobile device and the merchant location.

21. The system of claim 17, further comprising:
means for retrieving an identifier for a second customer order, wherein the second customer order is to be provided at the merchant location;
means for receiving a second customer mobile device identifier;
means for associating the identifier for the second customer order with the second customer mobile device identifier;
means for determining a location of a second customer mobile device that is associated with the second customer mobile device identifier;
means for determining a distance between the location of the second customer mobile device and the merchant location;
means for providing for display the identifier for the second customer order along with arrival information for the second customer that is based on the distance between the location of the second customer mobile device and the merchant location; and
prioritizing the identifier for the first customer order relative to the identifier for the second customer order along using the arrival information for the first customer and the arrival information for the second customer.

22. The system of claim 21, wherein the means for prioritizing further comprises:
means for determining an arrival time for the first customer mobile device at the merchant location using the distance between the location of the first customer mobile device and the merchant location;
means for determining an arrival time for the second customer mobile device at the merchant location using the distance between the location of the second customer mobile device and the merchant location; and
means for prioritizing the display of the identifier for first customer order and the display of the identifier for the second customer order using the arrival time for the first customer mobile device at the merchant location and the arrival time for the second customer mobile device at the merchant location.

23. The system of claim 17, wherein the first customer order is a food order.
